(19) United States
(12) Patent Application Publication
(10) Pub. No.: US 2025/0075953 A1
(43) Pub. Date: Mar. 6, 2025

(54) REFRIGERANT ACCUMULATOR

(71) Applicant: TI Automotive Technology Center GmbH, Rastatt (DE)

(72) Inventors: Sebastian BRIXNER, Edingen-Neckarhausen (DE); Werner Merz, Gaggenau (DE); Konrad Kocurek, Tychy (PL); Nicolas Hoss, Rastatt (DE)

(21) Appl. No.: 18/811,065

(22) Filed: Aug. 21, 2024

(30) Foreign Application Priority Data
Aug. 29, 2023 (EP) 23194053.7
Sep. 28, 2023 (EP) 23200617.1

(51) Int. Cl. F25B 43/00; B01D 17/02; F25B 43/02

(52) U.S. Cl. CPC F25B 43/006; B01D 17/0202; B01D 17/0217; F25B 43/02

(57) ABSTRACT

A refrigerant accumulator, comprising a housing with at least one inlet opening and at least one outlet opening, wherein a device is arranged in the housing, wherein the device is allocated to the inlet opening and/or the outlet opening.

### RELATED APPLICATIONS

The present disclosure claims priority to and the benefit of European Application 23194053.7, filed on Aug. 29, 2023, and European Patent Application 23200617.1, filed Sep. 28, 2023 the entire contents of each of which are incorporated herein by reference.

### FIELD

The disclosure relates to a refrigerant accumulator comprising a housing with at least one inlet opening and at least one outlet opening. This type of refrigerant accumulator is often used in mobile air conditioning systems, for example in vehicle air conditioning systems.

### BACKGROUND

A refrigerant circulates in an air conditioning system, the refrigerant being brought to a higher pressure level by a compressor. It is necessary to supply the compressor with a lubricant to ensure its functionality. During the compression process, some of the lubricant can get into the refrigerant and thus circulate in the refrigerant. In order to prevent the lubricant from circulating permanently in the cooling circuit and to be fed back into the compressor, the lubricant is separated from the refrigerant in a refrigerant accumulator. The accumulator usually comprises a bottle-shaped housing, which is closed at the top by a cover, wherein an inlet opening, and an outlet opening are introduced in the cover.

The refrigerant flows into the accumulator via the inlet opening and is influenced by a device arranged in the housing in such a way that a flow is formed inside the housing in which the lubricant is separated from the refrigerant. The lubricant finally collects in the bottom region of the housing and can be removed from the accumulator via a suction pipe or similar and fed back into the compressor.

Another problem is water that has entered the refrigeration circuit, for example during installation. In order to remove the water, it is known from the state of the art to arrange a desiccant, for example based on silica gel, in the accumulator. The desiccant is located in an air-permeable container and absorbs the water contained in the refrigerant flowing through the accumulator.

### BRIEF SUMMARY

The present disclosure provides a refrigerant accumulator that can be manufactured at low cost and has a long service life.

One refrigerant accumulator according to the disclosure comprises a housing with at least one inlet opening and at least one outlet opening, wherein a device is arranged in the housing, wherein the device is allocated to the inlet opening and/or the outlet opening.

The device arranged in the housing influences the flow of refrigerant flowing through the inlet opening and can additionally be provided with other functions, for example functions for the removal of the lubricant that collects in the bottom region of the housing. The device is preferably a separate component that is inserted into the housing.

The device can have at least one guide element for influencing the flow of the refrigerant flowing into the housing via the inlet opening. In particular, the guide element can have a channel that is curved in sections. The refrigerant flowing in via the inlet opening is directed into the interior of the housing via the channel and the flow of refrigerant is deflected by the channel curved in sections. This can create a vortex current, which improves the separation efficiency of the lubricant carried in the refrigerant. Due to the centrifugal force acting on the lubricant, the lubricant separates from the refrigerant on the wall of the housing and collects in the bottom region.

The housing can be closed by a cover, wherein the inlet opening and the outlet opening are introduced in the cover. This simplifies the manufacturability of the accumulator, and it is also possible to manufacture the cover and housing from different materials. For example, the cover can be made of metallic material and the housing of a fiber composite material. Alternatively, the housing can also be made of metallic material. The device is preferably made of injection-moldable plastic.

The device can be held on the cover in a form-fitting manner. In this embodiment, the device and cover can form a pre-assembled unit that can be inserted into the housing, wherein the housing and cover are connected to each other in a media-tight manner after the cover has been inserted. The form-fitting connection between the device and the cover means that the device is firmly attached to the cover in a loss-proof manner, and the connection can be made easily and without additional tools. The connection between housing and cover can be designed as a crimp connection. To improve tightness, a seal can be arranged between cover and housing.

The guide element can be held in the inlet opening in a form-fitting manner. This means that the guide element is fixedly allocated to the inlet opening. Preferably, the device and/or the guide element are fixed to the cover via a snap-on connection. A snap-on connection is easy and inexpensive to manufacture and allows for a fitting of the device to the cover without tools. The snap-on connection comprises several snap hooks which are preferably formed from the device, the snap hooks preferably have projections that engage in congruently shaped recesses that are introduced in the cover, for example in the inlet opening of the cover.

Alternatively or additionally, the device can also be fixed in the outlet opening in a form-fitting manner. For this purpose, a snap-on connection can be formed from the device which engages form-fittingly in corresponding structures in the outlet opening.

For the embodiment of the form-fitting connection, specifically the snap-on connection, the device can have a tubular connecting piece that is inserted into the inlet opening. The free end of the connecting piece can be formed with circumferential lug-like snap hooks that engage form-fittingly in a circumferential groove, wherein the groove can be introduced in the inner wall of the inlet opening.

The snap-on connection can be allocated to a securing means that prevents the snap-on connection from being unintentionally released. For this purpose, a securing means in form of a securing sleeve can be inserted into the free end of the connecting piece. The securing means can be tubular and have a collar projecting radially outwards on one end face. The outer diameter of the securing means preferably corresponds essentially to the inner diameter of the free end of the connecting piece formed by the snap hooks when the snap hooks are latched in the groove. The securing means blocks the snap hooks and prevents them from moving radially inwards and coming loose from the groove. This can prevent the snap hooks and therefore the device from unintentionally detaching from the cover.

The device can be equipped with a holding device for receiving a desiccant container. In this embodiment, it is advantageous that the desiccant container can be arranged in a suspended manner in the housing, wherein the desiccant container can influence the flow of the refrigerant. It is particularly advantageous that the desiccant container has a large contact surface with the refrigerant and therefore has a particularly good drying effect.

The holding device can be formed in a hook-shaped manner. In this embodiment, the desiccant container has an opening into which the holding device can be inserted. This way, an easy installation of the desiccant container in the housing is possible.

The desiccant container preferably comprises a porous material, the desiccant container may be in form of a bag or the like. Advantageous porous materials are non-woven fabrics. Silica gel, which is inserted into the container, can be used as a desiccant. The desiccant container can be formed, so that it is relatively flat, similar to a bag, and accordingly has two main sides which can also be curved.

The outlet opening can be allocated to a suction pipe which extends from the cover to the bottom of the housing. The suction pipe can be used to remove any lubricant that collects in the bottom region of the housing from the accumulator and feed it to the compressor.

The device can have an outlet channel which opens into the outlet opening, wherein the suction pipe is in flow-conducting connection with the outlet channel. A cross-sectional constriction can be formed in the outlet channel. In the region of the cross-sectional constriction, the cross-section is preferably reduced by ¼ to ½ of the initial cross-section. To homogenize the flow, the transitions to the cross-sectional constriction are formed conical on both sides.

Preferably, the suction pipe opens into the outlet channel in the region of the cross-sectional constriction. The refrigerant flows through the outlet channel and is accelerated in the region of the cross-sectional constriction. Due to the Venturi principle, a vacuum is created in the region of the cross-sectional constriction, so that lubricant is first drawn in from the bottom region of the housing via the suction pipe and can then be conveyed out of the accumulator with the refrigerant via the outlet opening. The arrangement of outlet channel and suction pipe is particularly compact and enables the suction of lubricant, which collects at the bottom of the housing, in the direction of the outlet channel allocated to the cover. A particular advantage is that no auxiliary energy is required for the suction and conveying of the lubricant. Together with the device, the suction pipe can form a pre-assembled unit.

The outlet channel can be fixed in the outlet opening in a form-fitting manner. Preferably, the outlet channel is part of the device.

### BRIEF DESCRIPTION OF THE DRAWINGS

Some embodiments of the refrigerant accumulator according to the disclosure are explained in more detail below with reference to the figures. These show, each schematically:

FIG. 1 a refrigerant accumulator in three-dimensional representation in section;

FIG. 2 a device in detail;

FIG. 3 a guide element in detail;

FIG. 4 the snap-on connection of the cover and the device in detail;

FIG. 5 the securing means for the device in detail;

FIG. 6 a device with a desiccant container and a suction pipe;

FIG. 7 a device with a desiccant container and a suction pipe;

FIG. 8 a device with a holding device and a desiccant container in detail;

FIG. 9 the device according to FIG. 8;

FIG. 10 a housing with a device and a suction pipe;

FIG. 11 a sectional view of the device in the region of the outlet channel;

FIG. 12 a transparent representation of the housing with a cover, an alternatively designed device and a desiccant container;

FIG. 13 a side view of an alternatively designed device;

FIG. 14 the device according to FIG. 13 in three-dimensional representation;

FIG. 15 the device according to FIG. 13 in bottom view.

### DETAILED DESCRIPTION

The figures show a refrigerant accumulator 1 which is part of an air conditioning circuit of a mobile air conditioning system. The mobile air conditioning system is, in particular, the air conditioning system of a vehicle. The air conditioning system comprises a closed circuit in which a refrigerant circulates. The refrigerant is compressed by a compressor and then enters a condenser where the refrigerant is liquefied. After leaving the condenser, the refrigerant is fed to a throttle and then flows to the evaporator, where the refrigerant absorbs heat. The refrigerant is then fed to the accumulator 1. In the accumulator, liquid components are separated from the refrigerant and then fed back into the compressor.

The refrigerant accumulator 1 comprises a housing 2 which is formed essentially cylindrical and accordingly has a cylinder wall 13 and a bottom 11. On the side opposite to the bottom 11, the housing 2 is closed by a cover 8. In the cover 8, an inlet opening 3 and an outlet opening 4 are introduced. In the housing 2, a device 5 is arranged, which is allocated to the inlet opening 3 and the outlet opening 4.

The device 5 has a guide element 6 for influencing the flow of the refrigerant flowing into the housing 2 via the inlet opening 3. The guide element 6 is formed from the device 5 and has a channel 7 that is curved in sections. The refrigerant flowing into the housing 2 via the inlet opening 3 is directed onto a circular path by the channel 7 curved in sections, and a vortex current is formed inside the housing 2. Due to the centrifugal force, the liquid lubricant separates from the refrigerant. The lubricant is thrown out of the refrigerant onto the cylinder wall 13 and collects on the bottom 11.

The outlet opening 4 is allocated to a suction pipe 10 which extends from the cover 8 to the bottom 11 of the housing 2. The device 5 has an outlet channel 12 which opens into the outlet opening 4. The outlet channel 12 is formed from the device 5. The suction pipe 10 opens into the outlet channel 12 in the region of a cross-sectional constriction 15. When refrigerant flows through the outlet channel 12, a vacuum forms in the region of the cross-sectional constriction 15, the vacuum enabling lubricant to be drawn in from the bottom 11 of the housing 2 via the suction pipe 10 and conveyed out of the accumulator 1 with the refrigerant via the outlet opening 4.

The device 5 is formed from plastic and manufactured by injection molding. The device 5 is held on the cover 8 in a form-fitting manner. Form-fitting elements are formed from the guide element 6 and the outlet channel 12, the form-fitting elements engaging in correspondingly shaped recesses in the inlet opening 3 and the outlet opening 4. The form-fitting elements create a snap-on connection between the device 5 and the cover 8.

The device 5 is equipped with a holding device 9 for receiving a desiccant container 20. The holding device 9 is formed in a hook-shaped manner and receives a desiccant container 20 which is arranged in a suspended manner on the holding device 9. The desiccant container 20 is formed in form of a bag which is closed along the edges. The desiccant container is formed from porous material, in this case non-woven fabric. An opening 14 is provided in the region of one edge of the desiccant container 20 into which the holding device 9 is inserted.

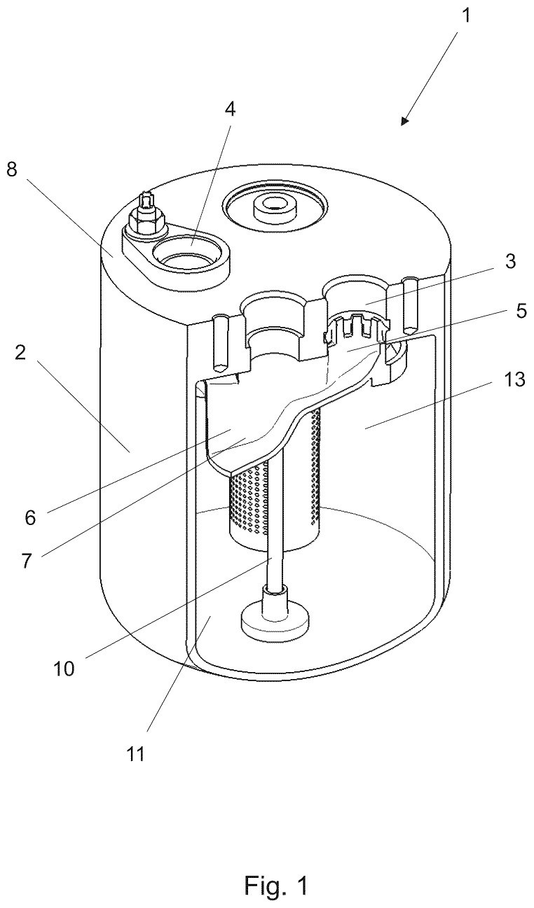

FIG. 1 shows the refrigerant accumulator 1 in a three-dimensional sectional view. The guide element 6 formed from the device 5 opens into the inlet opening 3 introduced in the cover 8. A connecting piece 25 is formed from the guide element 6, the connecting piece protruding into the inlet opening 3. On the free end of the connecting piece 25, lug-like snap hooks 22 are formed circumferentially that engage form-fittingly in a circumferential groove 19 formed in the inner wall of the inlet opening 3.

Starting from the inlet opening 3, the connecting piece 25 merges into a radially extending, spirally curved channel 7. This way, the refrigerant flowing through the channel 7 is deflected into a circular path and flows along the cylinder wall 13 of the housing 2 into the interior of the accumulator 1.

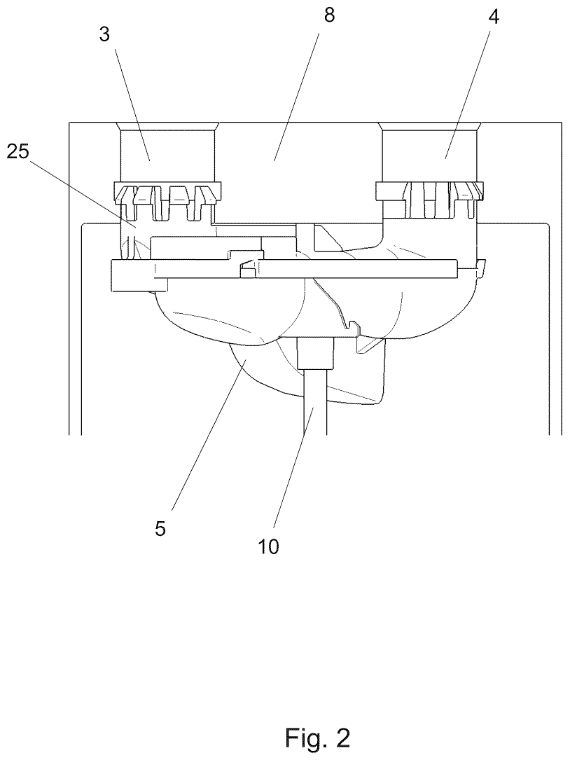

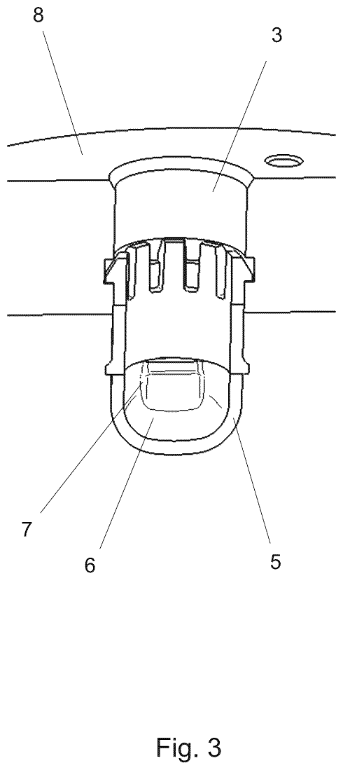

FIG. 2 shows the device 5 in detail. It can be seen that snap hooks 22 are formed circumferentially both from the connecting piece 25 allocated to the inlet opening 3 and from the connecting piece allocated to the outlet opening 4 that engage form-fittingly in circumferential grooves 19 that are introduced in the inner wall of the inlet opening 3 and the outlet opening 4. This attachment is also shown in detail in FIG. 3.

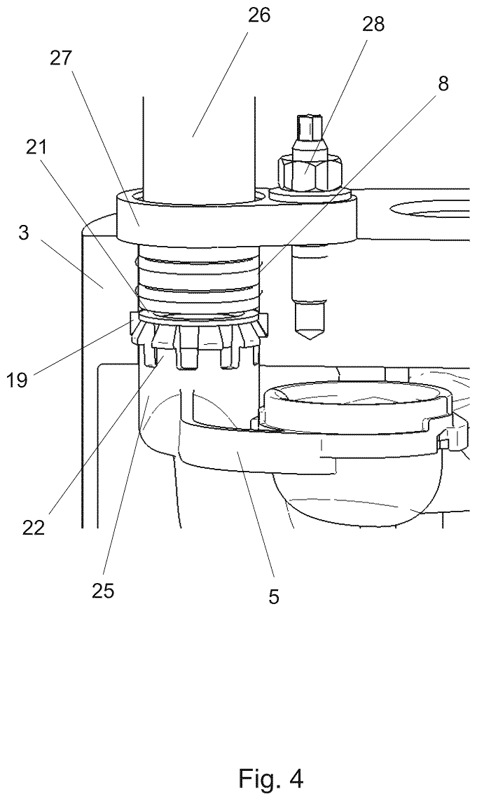

FIG. 4 shows in detail the snap-on connection between the cover 8 and the device 5 in the region of the inlet opening 3. The device 5 has a tubular connecting piece 25 that is inserted into the inlet opening 3. On the free end of the connecting piece 25, lug-like snap hooks 22 are formed circumferentially that engage form-fittingly in the circumferential groove 19 formed in the inner wall of the inlet opening 3.

A tube 26 is inserted into the inlet opening 3, the tube being fixed to the cover 8 via a flange 27 and a fastening element 28. The tube 26 is provided with seals which bear sealingly against the inner wall of the inlet opening 3.

In the embodiment shown in FIG. 4, a securing means 21 in form of a securing sleeve is inserted into the free end of the connecting piece 25. The securing means 21 is formed tubular and has a collar 24 projecting radially outwards on one end face. The collar 24 bears against the end face of the connecting piece 25 and prevents the securing means 21 from slipping completely into the connecting piece 25. The outer diameter of the securing means 21 corresponds essentially to the inner diameter of the free end of the connecting piece 25 formed by the snap hooks 22, wherein the snap hooks 22 are latched in the groove 19. The securing means 21 blocks the snap hooks 22 and prevents them from moving radially inwards. This can prevent the snap hooks 22 and therefore the device 5 from unintentionally detaching from the cover 8. In particular, the snap hooks 22 can be prevented from coming loose during the assembly of the tube 26.

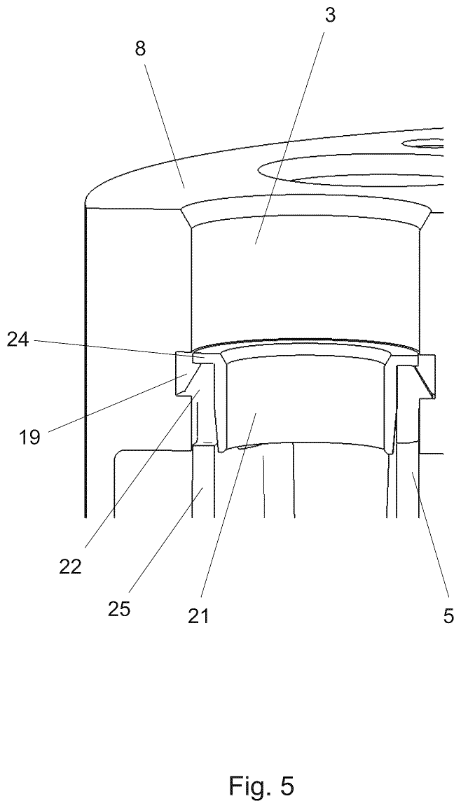

FIG. 5 shows in detail the embodiment according to FIG. 4 with the connecting piece 25 of the device 5 together with the snap hook 22 as well as the cover 8 and the securing means 21 in sectional view.

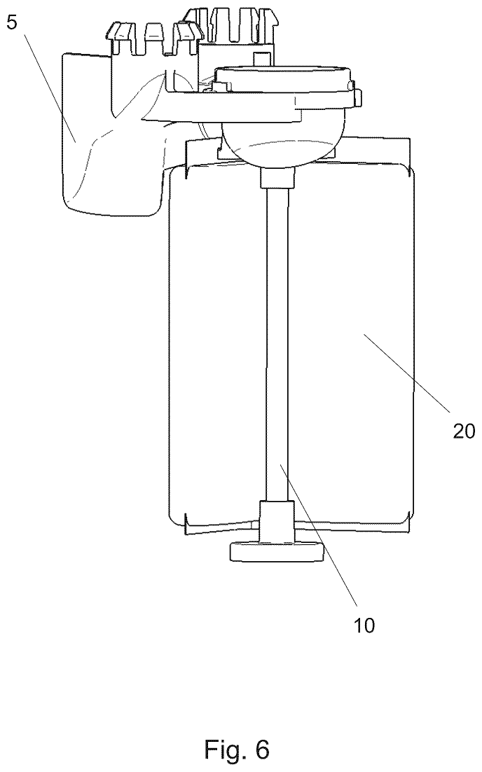

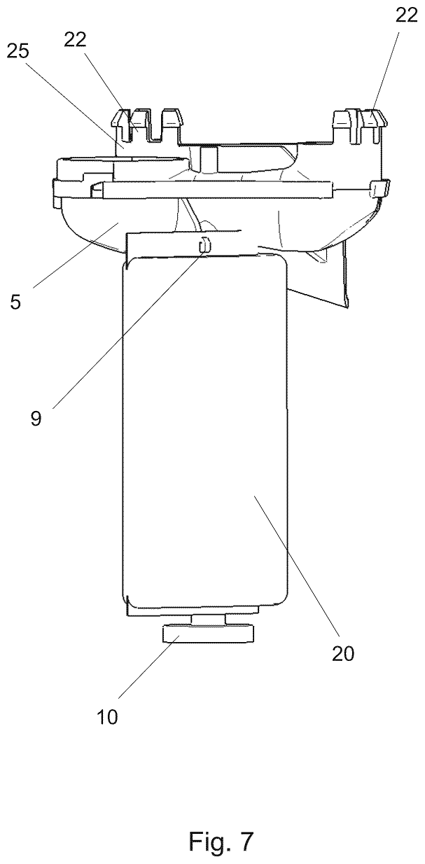

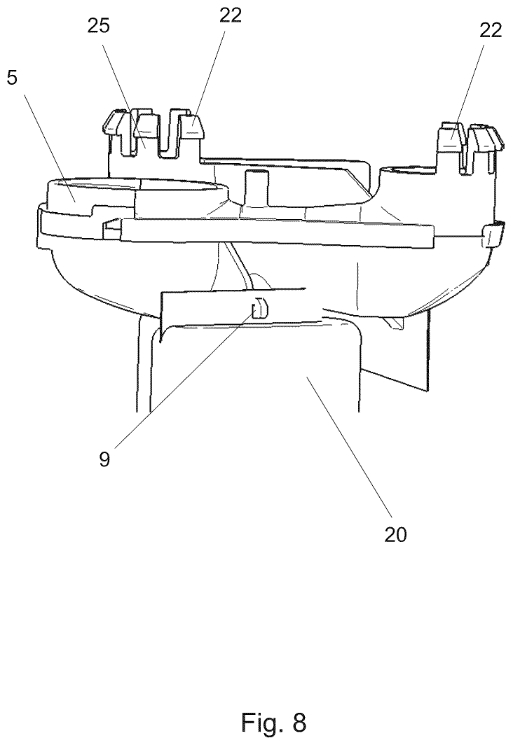

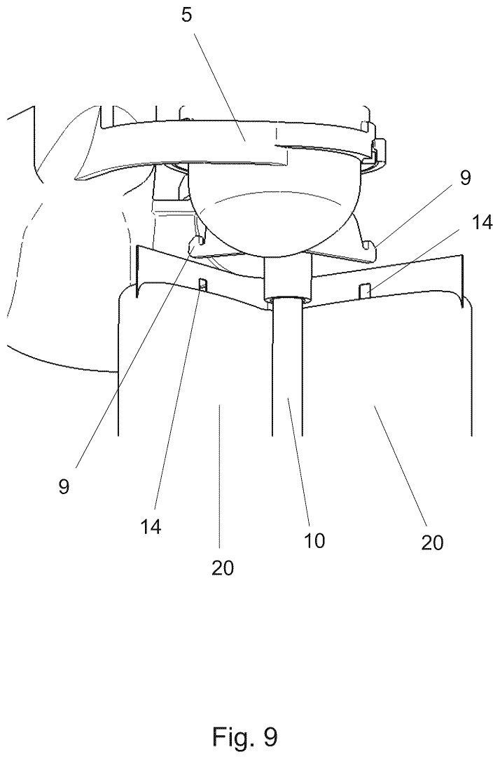

FIG. 6 shows a rear view of an arrangement consisting of the device 5, the suction pipe 10 and the desiccant container 20. FIG. 7 shows a front view of the arrangement shown in FIG. 6. FIG. 8 shows in detail the device 5 in the region of the holding device 9, including the desiccant container 20 attached to the holding device 9. FIG. 9 shows a rear view of the device according to FIG. 8. For a better illustration, the desiccant containers 20 are shown with the openings 14 at a distance from the holding devices 9. In the device shown in FIGS. 6 to 9, two desiccant containers 20 are provided which are arranged in a suspended manner on the device 5 via the holding device 9. For this purpose, the holding devices 9 protrude through the openings 14 of the desiccant containers 20.

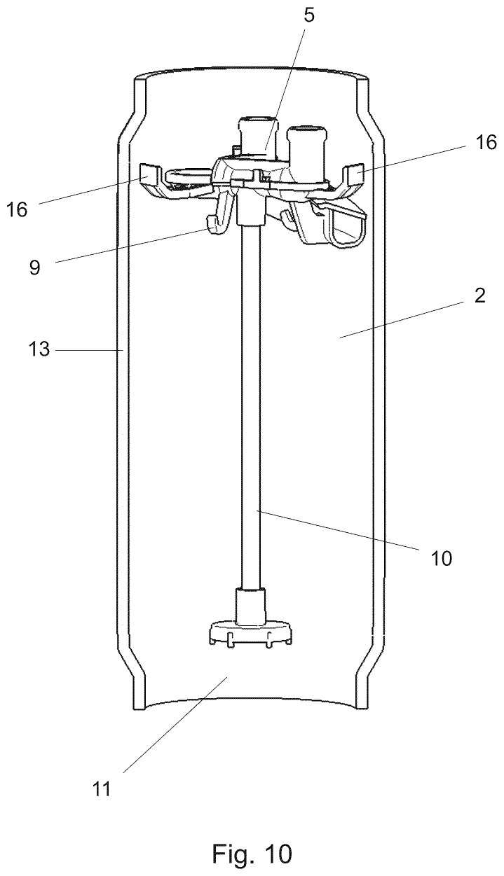

FIG. 10 shows a transparent representation of a housing 2 with a device 5 arranged therein with a suction pipe 10 and alternatively designed connecting elements 16 for fastening the device 5 to the cover 8.

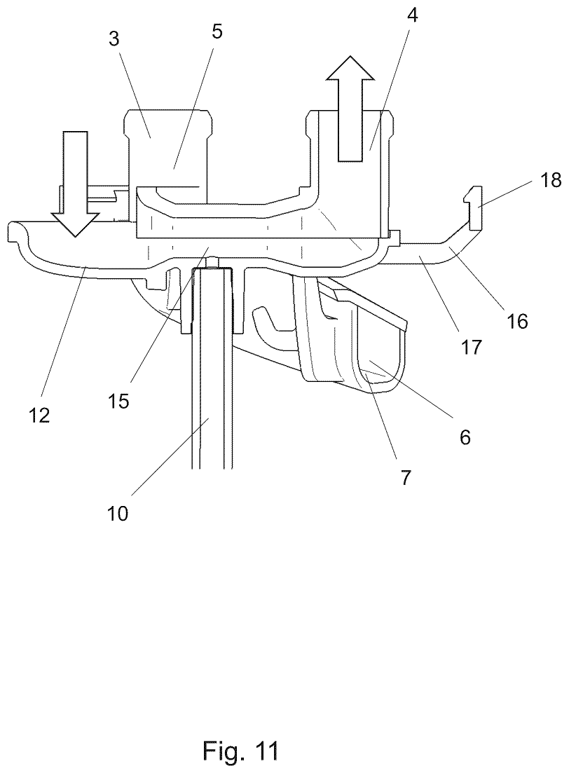

FIG. 11 shows a sectional view of the device 5 in the region of the outlet channel 12 in detail. In this embodiment, connecting elements 16 are formed from the device 5, which engage form-fittingly in the cover 8. The connecting elements 16 comprise webs 17 which extend radially in the direction of the cylinder wall 13. Curved snap hooks 18 are formed at the free ends of the webs 17, the snap hooks engaging in a recess made in the cover 8 on the circumferential side in form of a circumferential groove 19.

The device 5 has an outlet channel 12 which opens into the outlet opening 4. The outlet channel 12 is formed from the device 5. The suction pipe 10 opens into the outlet channel 12 in the region of a cross-sectional constriction 15. In the region of the cross-sectional constriction 15, the cross-section of the outlet channel 12 reduces by ¼ to ½ of the initial cross-section. When refrigerant flows through the outlet channel 12, a vacuum is created in the region of the cross-sectional constriction 15 due to the Venturi principle, the vacuum enabling lubricant to be drawn in from the bottom 11 of the housing 2 via the suction pipe 10 and conveyed out of the accumulator 1 with the refrigerant via the outlet opening 4. The embodiment of the outlet channel 12 with a cross-sectional constriction 15 and a suction pipe 10 opening into it is independent of the embodiment of the attachment of the device 5 to the cover 8 and is accordingly also realized in the device 5 according to FIGS. 2 to 7.

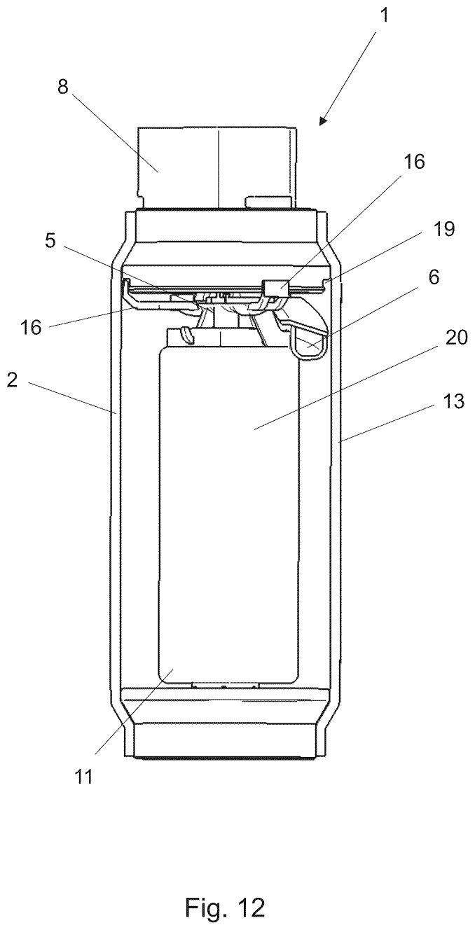

FIG. 12 shows a transparent representation of a housing 2 with a device 5 arranged therein with a desiccant container 20 and alternatively designed connecting elements 16 for fastening the device 5 to the cover 8.

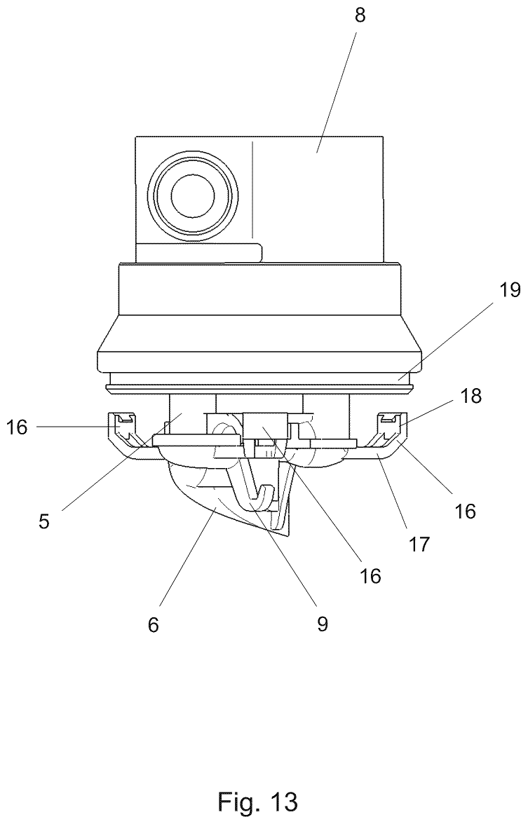

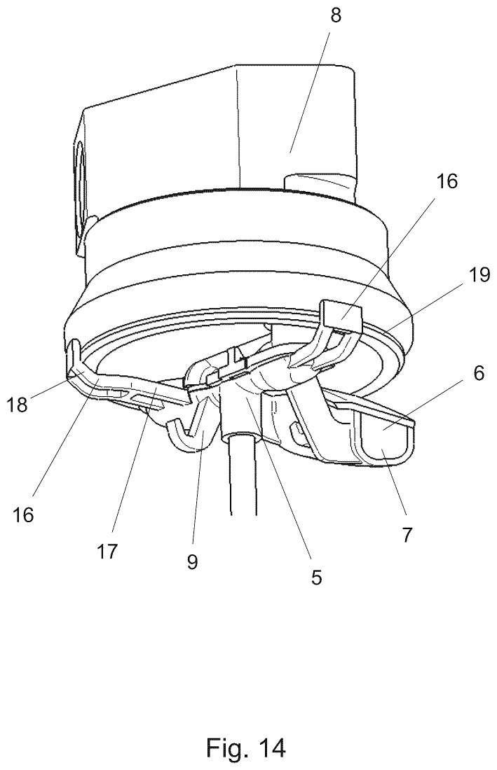

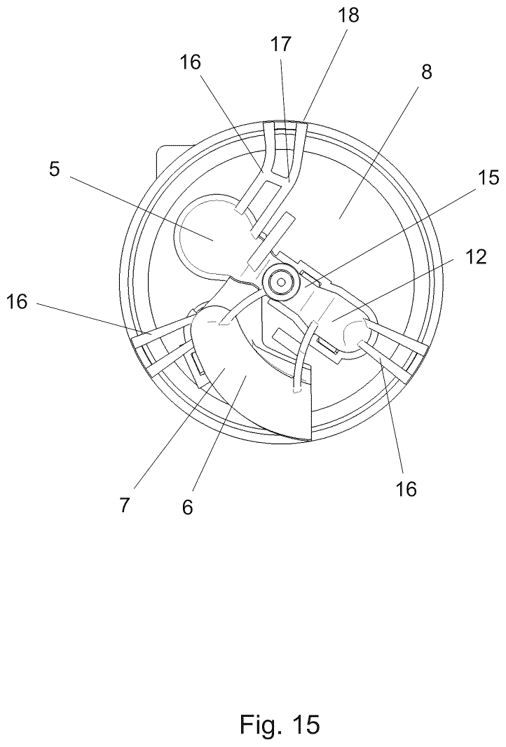

FIG. 13 shows the device 5 in detail before it is mounted on the cover 8. FIG. 14 shows the device 5 mounted on the cover in a three-dimensional representation and FIG. 15 shows the device 5 according to FIG. 14 in bottom view.

1. A refrigerant accumulator, comprising a housing with at least one inlet opening and at least one outlet opening, wherein a device is arranged in the housing, wherein the device is allocated to the inlet opening and/or the outlet opening.

2. The refrigerant accumulator according to claim 1, wherein the device has a guide element for influencing the flow of the refrigerant flowing into the housing via the inlet opening.

3. The refrigerant accumulator according to claim 2, wherein the guide element has a channel that is curved in sections.

4. The refrigerant accumulator according to claim 1, wherein the housing is closed by a cover, wherein the inlet opening and the outlet opening are introduced in the cover.

5. The refrigerant accumulator according to claim 4, wherein the device is held on the cover in a form-fitting manner.

6. The refrigerant accumulator according to claim 2, wherein the guide element is held in the inlet opening in a form-fitting manner.

7. The refrigerant accumulator according to claim 4, wherein the device and/or the guide element are fixed to the cover via a snap-on connection.

8. The refrigerant accumulator according to claim 7, wherein a securing means is allocated to the snap-on connection.

9. The refrigerant accumulator according to claim 1, wherein the device is equipped with a holding device for receiving a desiccant container.

10. The refrigerant accumulator according to claim 9, wherein a desiccant container is arranged in the housing and is held on the holding device.

11. The refrigerant accumulator according to claim 4, wherein the outlet opening is allocated to a suction pipe which extends from the cover to the bottom of the housing.

12. The refrigerant accumulator according to claim 1, wherein the device has an outlet channel which opens into the outlet opening, wherein the suction pipe is in flow connection with the outlet channel.

13. The refrigerant accumulator according to claim 12, wherein the outlet channel has a cross-sectional constriction.

14. The refrigerant accumulator according to claim 13, wherein the suction pipe opens into the outlet channel of the device in the region of the cross-sectional constriction.

15. The refrigerant accumulator according to claim 12, wherein the outlet channel is fixed in the outlet opening in a form-fitting manner.
